(19) United States
(12) Patent Application Publication
(10) Pub. No.: US 2004/0056185 A1
(43) Pub. Date: Mar. 25, 2004

(54) Light scanning device of laser printer

(75) Inventor: Jae-Hwan Yoo, Yongin-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/436,998

(22) Filed: May 14, 2003

(30) Foreign Application Priority Data
Sep. 19, 2002 (KR) 2002-57243

(51) Int. Cl. H01J 3/14; H01J 5/16

(52) U.S. Cl. 250/236

(57) ABSTRACT

A light scanning device of a laser printer to scan light to form a latent image on a photosensitive drum according to image data. The light scanning device includes a plurality of laser beam sources disposed to be parallel with each other, to emits laser beams having various wavelengths; a plurality of collimator lenses to transform the laser beam into parallel light; and a first optical output portion having a plurality of optical members to reflect or transmit the light output from each collimator lens through one surface, and reflect or transmit the reflected light through the other surface according to wavelength. Thus, a single output path is formed at an end-most portion thereof. The device further includes a scanning unit to reflect the light output from the first optical output portion; and a second optical output portion having a plurality of optical members disposed in a row so as to receive the light output from the scanning unit at a front-most portion and selectively reflect or transmit the light according to the wavelength, and selectively reflect or transmit the light reflected at the front-most portion according to the wavelength and scan the light to a corresponding photosensitive drum.

### CROSS-REFERENCE TO RELATED APPLICATIONS

This application claims the benefit of Korean Application No. 2002-57243, filed Sep. 19, 2002, in the Korean Intellectual Property Office, the disclosure of which is incorporated herein by reference.

### BACKGROUND OF THE INVENTION

1. Field of the Invention

The present invention relates to a laser printer, and more particularly, to a light scanning device for scanning light to form a latent image on a photosensitive drum according to image data.

2. Description of the Related Art

Generally, a laser printer is an apparatus in which toner is absorbed on a photosensitive drum according to image data, and the toner absorbed on the photosensitive drum is then transferred to a print medium, and thus an image can be reproduced on the print medium. At this time, light is scanned on the photosensitive drum to form a latent image according to the image data, and the toner is absorbed to the latent image formed by the light. The laser printer is a non-impact type which has the advantage of rapid speed and less noise, and thus it is widely used in various fields.

In such a laser printer, a monochrome laser beam printer (LBP) is provided with one light scanning device which linearly scans the light on the photosensitive drum, and a color LBP is provided with four light scanning devices corresponding to each of cyan, yellow, magenta and black.

However, in order to simplify construction of the color LBP, a tandem type light scanning device by which only one light scanning device can be applied to the color LBP has been recently developed. An example of the tandem type light scanning device is disclosed in Korean Laid-Open Publication No. 2000-0047538 (Jul. 25, 2000).

FIG. 1 is a schematic view showing a structure of a conventional tandem type light scanning device 10. The conventional tandem type light scanning device includes an optical case 12, light sources 14A, 14B, 14C, 14D, first reflecting mirrors 17A and 17B, second reflecting mirrors 18A, 18B, 18C, and 18D, image forming lens systems 20A and 20B, cylinder mirrors 24A, 24B, 24C, and 24D and a scanning unit 22. The conventional tandem type light scanning device further includes a plurality of synchronization detecting units (not shown) to control horizontal synchronization of a scanning line.

Each of the light sources 14A, 14B, 14C, 14D has a laser diode (not shown) and a collimator lens. The scanning unit 22 has a polyhedral mirror 26 and a motor 28 to drive the polyhedral mirror 26. In addition, the image forming lens systems 20A and 20B that are positioned at an upper and lower side, with respect to the scanning unit 22, are provided with a pair of image forming lenses 21 and 23.

In the conventional tandem type light scanning device, laser beams 14Aa˜14Da emitted from the laser diode are transformed into parallel light by a collimating lens, and then reflected by the first reflecting mirror 17A. And, the laser beam reflected from the first reflecting mirror 17A is focused on a deflecting surface 26A of the polyhedral mirror 26 through the image forming lens systems 20A and 20B. The laser beam focused on the deflecting surface 26A of the polyhedral mirror 26 is output to the second reflecting mirrors 18A˜18D through the image forming lens systems 20A and 20B, and then output to the corresponding cylinder mirrors 24A˜24D. Sequentially, the laser beam is reflected from the cylinder mirrors 24A˜24D, and then scanned to corresponding photosensitive drums 38A˜38D. At this time, the laser beams 14a˜14d pass through the image forming lens systems 20A and 20B, while forming a predetermined angle α with respect to a scanning plane S before and after being reflected by the scanning unit 22.

When the laser beam is scanned from the light scanning device as described above, a latent image is formed on the corresponding photosensitive drums 38A˜38D, and then, an image is reproduced through a typical printing process on a print medium.

In the conventional tandem type light scanning device as described above, since two pairs of image forming lens systems 20A and 20B are disposed to be opposite to each other, and the reflecting mirror for forming an optical path and the synchronization detecting unit for the horizontal synchronization are provided to each light source 14A-14D, the structure of the light scanning device is complicated and difficult to control.

Further, since the number of components of the light scanning device is increased, there is the problem of increased fabrication costs.

Further, since the laser beam which is incident/output to/from the image forming lens system has the predetermined angle with respect to the scanning plane, there is another problem of a bow of the scanning line. In order to solve this problem, a separate compensating unit is required.

In addition, since the image forming lens systems are arranged to be opposite to each other with the scanning unit in the center, two signals of four color image signals are scanned from the left to the right on the basis of a transferring direction of the print medium. Therefore, since two pairs of scanning directions with respect to the four color image signals are opposite to each other, it is impossible to obtain a correct color image. In other words, in order to obtain the correct color image, at least two image signals have to be scanned in a status that the left and right order is inverted. Therefore, there is yet another problem that additional devices for controlling the image signal are required.

### SUMMARY OF THE INVENTION

Therefore, it is an aspect of the present invention to provide a tandem type light scanning device which has a simple structure, and which can be simply controlled without a separate compensating process with respect to a scanning line.

Additional aspects and advantages of the invention will be set forth in part in the description which follows and, in part, will be obvious from the description, or may be learned by practice of the invention.

The foregoing and/or other aspects are achieved by providing a light scanning device including a plurality of laser beam sources disposed to be parallel with each other, to emit laser beams having various wavelengths according to image data; a plurality of photosensitive drums corresponding to the plurality of laser beam sources; a plurality of collimator lenses to transform the laser beams emitted from the laser beam sources into parallel light; a first optical output portion having a plurality of first optical members to reflect or transmit the parallel light through a first surface thereof, and reflect or transmit the reflected light through a second surface thereof according to the wavelengths, and thus output the laser beams of the various wavelengths along a single output path at an output portion thereof; a scanning unit to reflect the light output from the first optical output portion; and a second optical output portion having a plurality of second optical members disposed in a row so as to receive the light reflected from the scanning unit at an input portion thereof and selectively reflect or transmit the received light according to the wavelengths, and scan the reflected/transmitted light to the corresponding photosensitive drum.

The light scanning device may further include a focusing lens to focus the light output from the first optical output portion on a reflecting surface of the scanning unit, and an image forming lens to focus the light reflected by the scanning unit on the front-most optical member of the second optical output portion.

Further, the light scanning device may further include a synchronization detecting unit to detect a synchronization signal and control a horizontal synchronization of an image in the light reflected by the scanning unit, and a third optical member to selectively transmit or reflect the light which is incident to the synchronization detecting unit.

Meanwhile, the plurality of optical members may be disposed in various manners so as to have a single output path. The optical members may be disposed in a vertical direction or disposed to be inclined in a row at a desired angle. At this time, the plurality of optical members of the first and second optical output portions respectively have a different reflection and transmission region according to the wavelength of the incident light.

The plurality of optical members may be dichroic mirrors or transparent glasses with a dichroic coating. Each of the dichroic mirrors has a different reflection and transmission wavelength region at the first or second optical output portion. Furthermore, the plurality of optical members may be band pass filters.

In the light scanning device, the light having various wavelengths is transmitted through a single output path to the scanning unit, and the light corresponding to each color signal is output from the scanning unit to the signal path, and then scanned through the optical members on each photosensitive drum corresponding to each color signal, whereby a simple structure and a small size of the light scanning device can be obtained. Further, since the scanning unit also has the single output path and thus only one synchronization detecting unit is required, a separate compensating unit is not needed to compensate for the bow of the scanning line according to the synchronization detection adjusting unit or the image data. Therefore, fabricating costs are reduced.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a schematic view of an internal structure of a conventional tandem type light scanning device;

FIGS. 2 and 3 are a plan view and a side view, respectively, of an internal structure of a light scanning device according to an embodiment of the present invention;

FIG. 4 is a distribution chart of a reflectance and a transmittance with respect to light of a second and third dichroic mirror of FIG. 3; and

FIG. 5 is a view showing reflection and transmission of an optical member with respect to the light.

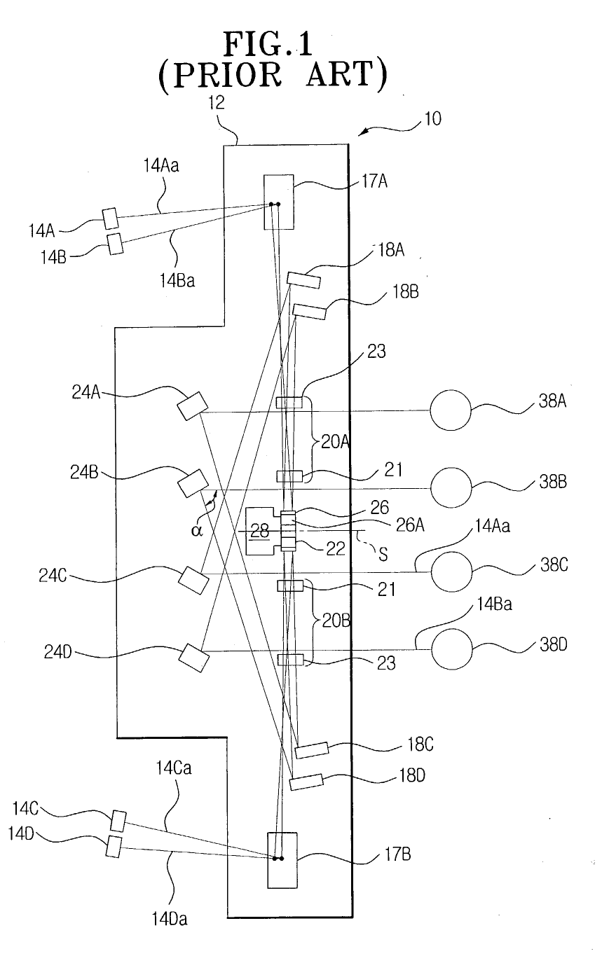

### DETAILED DESCRIPTION OF THE PREFERRED EMBODIMENT

Reference will now be made in detail to the present preferred embodiment of the present invention, an example of which is illustrated in the accompanying drawings, wherein like reference numerals refer to like elements throughout.

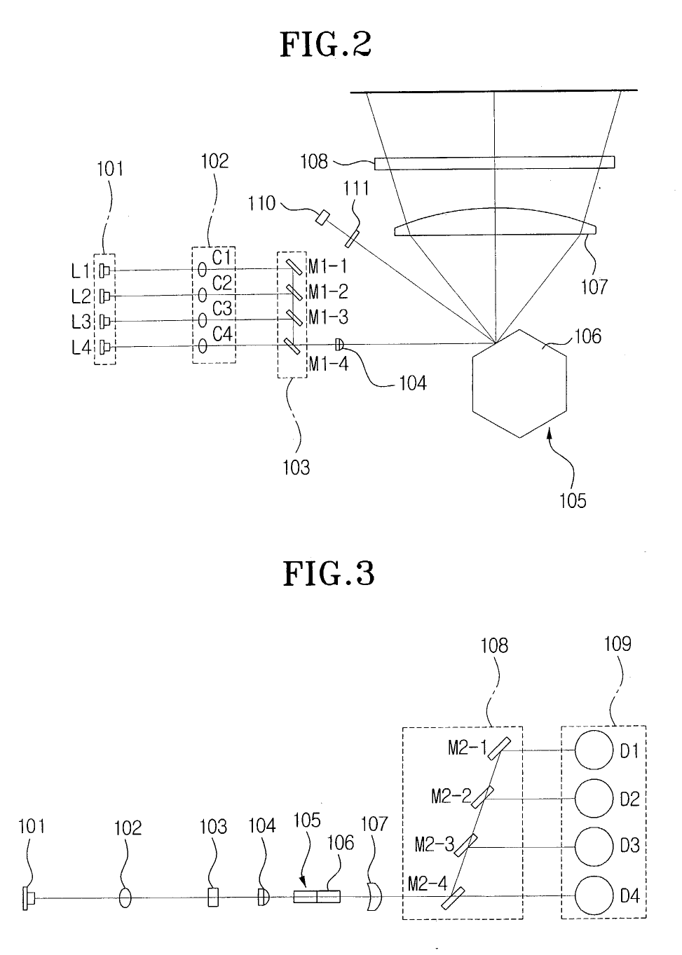

FIGS. 2 and 3 are a plan view and a side view of an internal structure of a light scanning device according to an embodiment of the present invention. A light scanning device includes a light source portion 101 having first through fourth laser diodes L1˜L4, a collimator lens portion 102 having first through fourth collimator lenses, a first optical output portion 103 having first through fourth dichroic mirrors M1-1˜M1-4, a cylinder lens 104, a scanning unit 105 including a polygonal reflecting mirror 106, an image forming lens 107, a second optical output portion 108 including fifth to eighth dichroic mirrors M2-1˜M2-4, a synchronization detecting unit 110, and a third optical member 111.

The first through fourth diodes L1˜L4 of the light source portion 101 are disposed to be parallel to each other in a row.

The first through fourth collimator lenses C1˜C4 are disposed in a row corresponding to respective laser diodes L1˜L4 so as to transform laser beams emitted from each laser diode L1˜L4 into parallel light.

The first through fourth dichroic mirrors M1-1˜M1-4 of the first optical output portion 103 are disposed to reflect or transmit the light, which is transmitted through each of the collimator lenses C1˜C4 and input through each surface, and form a single output path at its end-most portion. As shown in FIG. 2, each of the first to fourth dichroic mirrors M1-1˜M1-4 is inclined and thus reflects the incident beam at a right angle. The first through fourth dichroic mirrors M1-1˜M1-4 are entirely disposed in a row. However, as shown in FIG. 2, the first to fourth laser diodes L1˜L4 and the first through fourth collimator lenses C1˜C4 need not to be disposed in a row, and may be disposed at different distances according to wavelengths. Further, herein, although the first through fourth dichroic mirrors M1-1˜M1-4 are vertically disposed, this should not be considered as limiting. For example, these elements may be inclined so that the incident light can be reflected at a desired constant angle. In addition, all of the first through fourth dichroic mirrors M1-1˜M1-4 need not be dichroic mirrors. For example, in the case of the first dichroic mirror M1-1, a general reflecting mirror may be used.

The cylinder lens 104 focuses the light output from the first optical output portion 103 on a polyhedral mirror 106 of the scanning unit 105.

The scanning mirror 105 includes a motor (not shown) and the polygonal mirror 106, and reflects the light transmitted through the cylinder lens 104 at a predetermined angle.

The image forming lens 107 transmits the light reflected by the scanning unit 105 to the second optical output portion 108.

The second optical output portion 108 receives the light transmitted through the image forming lens 107 at its front-most portion, and reflects or transmits the light at the fifth through eighth dichroic mirrors M2-1˜M2-4 according to a wavelength of the light, and then scans the light to corresponding photosensitive drums D1˜D4.

The second optical output portion 108 and the first optical output portion 103 differ in that, in case of the first optical output portion 103, the light is output from its end-most portion but, in the case of the second optical output portion 108, the light is incident to its front-most portion. However, these elements have the same or similar structures with respect to reflection and transmission of the light according to wavelength. Therefore, a detailed description thereof will be omitted.

In the light scanning device as described above, the light, which is emitted from the first to fourth laser diodes L1˜L4 of the light source portion 101 according to an image to be printed, is transformed through the corresponding capacitor C1˜C4 of the collimator lens 102 into the parallel light, and then arrives at the corresponding first to fourth dichroic mirrors M1-1˜M1-4. At this time, the lights output from the laser diodes L1˜L4 of the light source portion 101 have the different wavelengths, respectively. For example, the first laser diode L1 emits light having a wavelength of 650 nm, and the second, third and fourth laser diodes emit laser beams having respective wavelengths of 780 nm, 850 nm and 950 nm.

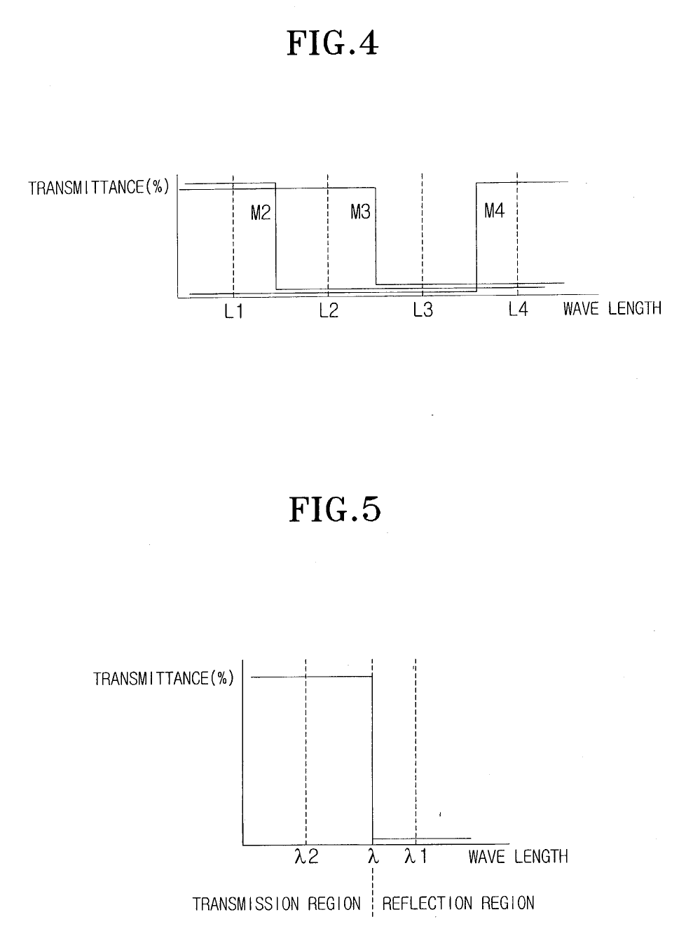

If the light having the different wavelengths is incident to the first optical output portion 103, the first through fourth dichroic mirrors M1-1˜M1-4 selectively reflect or transmit the laser beams through both surfaces thereof, and then output the laser beams from the end-most portions through the signal output path to the scanning unit. That is, the fourth dichroic mirror M1-4 transmits the light which is incident through the fourth collimator lens C4, but the first to third dichroic mirrors M1-1˜M1-3 reflect the light, which is incident through corresponding collimator lenses C1˜C3, in a vertical direction. And the second through fourth dichroic mirrors M1-2˜M1-4 selectively reflect or transmit the light reflected from the first through third dichroic mirrors M1-1˜M1-3 according to the wavelength, and then the light is reflected from the last dichroic mirror M1-4 to the scanning unit 105. FIG. 4 is a view showing a distribution of a transmittance of the second, third and fourth dichroic mirrors M1-2˜M1-4 according to wavelength. FIG. 5 is a view showing reflection and transmission of an optical member with respect to the incident light. A boundary of the reflection and the transmission is ‘λ’. If an incident wavelength is smaller than a wavelength λ1 of a reflection region, the incident light is reflected from a surface of the optical member, and if the incident wavelength is greater than a wavelength λ2 of a transmission region, the incident light is transmitted through the optical member.

On the basis of the reflection and transmission of the optical member with respect to the incident light, reflection and transmission characteristics of the first through fourth dichroic mirror M1-1˜M1-4 will be described. The first dichroic mirror M1-1 is a typical reflecting mirror, to reflect the light emitted from the first to fourth laser diodes L1˜L4. The second dichroic mirror M1-2 transmits the light emitted from the first laser diode L1 but reflect the light emitted from the second to fourth laser diodes L2˜L3. The third dichroic mirror M1-3 transmits the light emitted from the first and second laser diodes L1, L2 but reflects the light emitted from the third and fourth laser diodes L3, L4. The fourth dichroic mirror M1-4 reflects the light emitted from the first to third laser diodes L1˜L3 but transmits the light emitted from the fourth laser diode L4.

Due to the characteristics described above, the light emitted from the first laser diode L1 is reflected from a surface of the first dichroic mirror M1-1, and transmitted through the second and third dichroic mirrors M1-2, M1-3, and reflected by the fourth dichroic mirror M1-4, and then incident to the cylinder lens 104. The light emitted from the second laser diode L2 is reflected by a surface of the second dichroic mirror M1-2, and transmitted through the third dichroic mirror M1-3, and reflected by the fourth dichroic mirror M1-4, and then incident to the cylinder lens 104. The light emitted from the third laser diode L3 is reflected by the third dichroic mirror M1-3, and reflected again by the fourth dichroic mirror M1-4, and then incident to the cylinder lens 104. The light emitted from the fourth laser diode L4 is transmitted through the fourth dichroic mirror M1-4, and then incident to the cylinder lens 104. That is, since the laser beam which is incident to the cylinder lens 104 has the same output path regardless of the wavelength, in a region from the cylinder lens 104 to the image forming lens 107, the light scanning device can obtain the same effect as a mono laser beam printer using a single laser diode.

Sequentially, the laser beam, which is mixed with a plurality of wavelengths transmitting through the image forming lens 107, is selectively reflected by or transmitted through the fifth through eighth dichroic mirrors M2-1˜M2-4 of the second optical output portion 108, and then scanned to the corresponding photosensitive drums D1˜D4. Here, the arrangement structure of each of the dichroic mirrors M2-1˜M2-4 of the second optical output portion 108 is applied in the same way as that of each dichroic mirror M1-1˜M1-4 of the first optical output portion 103. In other words, the laser beam emitted from the fourth laser diode L4 transmits through the eighth dichroic mirror M2-4, and is then scanned to the fourth photosensitive drum D4. The laser beam emitted from the third laser diode L3 is reflected by the eighth dichroic mirror M2-4, and is reflected again by the seventh dichroic mirror M2-3, and is then scanned to the third photosensitive drum D3. The light emitted from the second dichroic mirror L2 is reflected by the eighth dichroic mirror M2-4, and is transmitted through the seventh dichroic mirror M2-3, and reflected again by the sixth dichroic mirror M2-2, and then scanned to the second photosensitive drum D2. The light emitted from the first laser diode L1 is reflected by the eighth dichroic mirror M2-4, and transmitted through the sixth and seventh dichroic mirrors M2-3 and M2-2 in turn, and reflected again by the fifth dichroic mirror M2-1, and then scanned to the first photosensitive drum D1.

Meanwhile, in order to control horizontal synchronization of a scanning line scanned on each photosensitive drum D1-D4, the synchronization detecting unit 110 detects the laser beam reflected at a desired position of the scanning unit 105 and then transferred to a control unit (not shown) of the system. At this time, the third optical member 111 to selectively reflect or transmit the laser beam may be disposed or omitted at an incident path through which the light is incident to the synchronization detecting unit 110. Herein, since the synchronization detecting units 110 detect the laser beam which is scanned through the signal incident path to each photosensitive drum D1˜D4, it is possible to synchronize the four scanning lines using only one synchronization detecting unit 110 without separate synchronization detecting units corresponding to each photosensitive drum D1-D4.

According to the tandem type light scanning device of the present embodiment, as described above, by using a proper arrangement structure of the light source having a plurality of wavelengths and the optical members having various light reflection and transmission regions corresponding to the wavelengths, the light having various wavelengths is transmitted through a single output path to the scanning unit 105. The light corresponding to each color signal is output from the scanning unit 105 to the signal path, and then scanned through the optical members on each photosensitive drum corresponding to each color signal, whereby a simple structure and a small size of the light scanning device can be obtained.

Further, since it is possible to control the horizontal synchronization of the light scanned on each photosensitive drum using only one synchronization detecting unit, separate compensating units are not needed to compensate for the bow of the scanning line according to the synchronization detection adjusting unit or the image data. Therefore, fabricating costs are reduced.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A light scanning device, comprising:
a plurality of laser beam sources disposed to be parallel with each other, to emit laser beams having various wavelengths according to image data;
a plurality of photosensitive drums corresponding to the plurality of laser beam sources;
a plurality of collimator lenses to transform the laser beams emitted from the laser beam sources into parallel light;
a first optical output portion having a plurality of first optical members to reflect or transmit the parallel light through a first surface thereof, and reflect or transmit the reflected light through a second surface thereof according to the wavelengths, and thus output the laser beams of the various wavelengths along a single output path at an output portion thereof;
a scanning unit to reflect the light output from the first optical output portion; and
a second optical output portion having a plurality of second optical members disposed in a row so as to receive the light reflected from the scanning unit at an input portion thereof and selectively reflect or transmit the received light according to the wavelengths, and scan the reflected/transmitted light to the corresponding photosensitive drums.

2. The device of claim 1, further comprising a focusing lens to focus the light output from the first optical output portion on a reflecting surface of the scanning unit.

3. The device of claim 2, further comprising an image forming lens to focus the light reflected by the scanning unit on the second optical member closest to the input portion thereof.

4. The device of claim 3, further comprising a synchronization detecting unit to detect a synchronization signal and control a horizontal synchronization of an image formed by the light reflected by the scanning unit.

5. The device of claim 4, further comprising a third optical member to selectively transmit or reflect the light which is incident to the synchronization detecting unit.

6. The device of claim 1, wherein the first and second optical members respectively have different reflection and transmission regions according to the wavelength of the incident light.

7. The device of claim 6, wherein the first optical members are disposed in a row.

8. The device of claim 7, wherein the first optical members are disposed perpendicular to an incident direction of the light.

9. The device of claim 1, wherein the first and second optical members are dichroic mirrors.

10. The device of claim 1, wherein the first and second optical members are transparent glasses on which dichroic is coated.

11. The device of claim 1, wherein the first and second optical members are band pass filters.

12. An apparatus comprising:
first and second laser sources to emit parallel first and second lasers having different wavelengths;
first and second optical members to selectively reflect/transmit the lasers according to the wavelengths to output the first and second lasers along a single path; and
third and fourth optical members to selectively reflect/transmit the lasers from the single path and output the first and second lasers along parallel paths.

13. The apparatus of claim 12, further comprising first and second photosensitive drums to respectively receive the lasers from the third and fourth optical members.

14. The apparatus of claim 12, wherein the first and second laser sources are parallel to each other in a row.

15. The apparatus of claim 14, wherein the first and second optical members are dichroic mirrors disposed in a row.

16. The apparatus of claim 14, wherein the first and second optical members are spaced from the first and second laser sources according to the wavelengths.

17. The apparatus of claim 16, wherein the first and second optical members are inclined relative to each other to reflect the first and second lasers at a desired angle.

18. The apparatus of claim 12, wherein the third and fourth optical members reflect/transmit the lasers according to the wavelengths.

19. An apparatus, comprising:
a light source to emit a beam having a plurality of wavelengths;
a plurality of optical members to receive the beam and having a plurality of reflection and transmission regions corresponding to the wavelengths; and
a scanning unit to receive the beam from the optical members along a single path.

20. The apparatus of claim 19, wherein the optical members comprise:
a reflecting member to reflect the beam; and
a dichroic mirror to transmit the light of one of the wavelengths and reflect the light of the remaining wavelengths.
